(19) United States
(12) Patent Application Publication
(10) Pub. No.: US 2006/0001954 A1
(43) Pub. Date: Jan. 5, 2006

(54) Crystal detection with scattered-light illumination and autofocus

(76) Inventors: Michael Wahl, Bonita, CA (US); Erik L. Novak, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/880,670

(22) Filed: Jun. 30, 2004

(51) Int. Cl. G02B 21/00

(52) U.S. Cl. 359/368; 359/385

(57) ABSTRACT

A scatter shutter is used to alternately provide non-scattered illumination for autofocus purposes and diffuse illumination for imaging purposes in a microscope system for high-throughput testing of protein samples in a multi-well tray. As the tray is being scanned continuously through the microscope objective for data acquisition, the scatter shutter is intermittently deactivated to allow collimated light to focus on the underside of the tray and produce autofocus signals, and then activated to produce diffused light and to image the protein sample in each well. The timing of each step is synchronized so as to place the droplet in focus prior to energizing the scatter shutter and switching to the imaging mode.

### BACKGROUND OF THE INVENTION

1. Field of the Invention

This invention is related in general to equipment and processes for high-throughout screening of biological samples. In particular, the invention consists of an optical microscope for detecting the formation of protein crystals in liquid droplets contained in a multi-well tray that is rapidly scanned through the microscope objective.

2. Description of the Related Art

In fast-throughput screening of biological samples, individual samples are loaded into separate wells of multi-well trays or plates, where they are treated with reagents (or otherwise processed) and screened for target results. In the case of proteins, they are typically crystallized out of a liquor and analyzed for molecular structure using X-ray diffraction techniques. For fast throughput, the protein solution is loaded as a droplet into each well of such a multi-well tray (typically a 96-well plate) and is processed through an incubation step designed to cause the precipitation of protein crystals. Each well is then analyzed by some means, typically an optical procedure, to identify the presence of crystals, which are then harvested and processed through an X-ray diffraction unit to characterize their molecular structure. This knowledge is then utilized to design drugs with specific therapeutic objectives.

The optical procedures utilized in the art to identify the presence of crystals in each well are microscopic techniques wherein the well is illuminated, the liquid droplet is imaged, and the presence of crystals is detected by some automatic process (typically based on numerical analysis of light intensity signals). For example, after a sample is imaged and the image is digitized to provide an optical density value for each image pixel (or other measure of light intensity), the information is used in conventional manner to identify and isolate each crystal within the sample, so that the crystals formed in the well can be counted for screening purposes.

It is critical that all imaging steps be carried out in focus for all wells in the trays, which are not constructed to optical standards of precision and may vary significantly in the vertical position of each well. Therefore, an autofocus mechanism is used to adjust the distance between the microscope objective and each sample well as the tray is scanned through a plane in front of the objective (or vice versa). A light source (typically a laser light which may or may not be the same as the illumination source used for imaging purposes) is used to provide the automatic focusing function by detecting the position of a reference point in each well (such as the bottom of the well or the corresponding underside of the tray) and adjusting the vertical position of the well relative to the microscope so that the droplet in the well is in focus. An empirical offset with respect to the reference point is normally used to focus the objective at a predetermined height within the droplet deemed appropriate to provide acceptable images throughout the multi-well tray. While the imaging function of the microscope is usually implemented from the top of the tray, the autofocus mechanism may be implemented from either side of the tray.

Two illumination techniques have been used in the art to illuminate the liquor and crystals contained in the wells for microscope imaging purposed, either from the top or the bottom of the multi-well tray (which is normally made of transparent material). The most common approach is bright-field illumination, wherein the sample is illuminated through the microscope objective with substantially well behaved light rays (collimated or in a well-defined cone) at a particular focal plane of the microscope objective. As illustrated in FIG. 1, the problem with this approach is the fact that the small amount of liquid in each well 10 of a multi-well plate, as a result of the surface tension of the liquid, forms a droplet 12 with a top curvature that makes the drop equivalent to an optical lens. Therefore, the light impinging on the surface 14 of the liquid droplet 12 at an angle of incidence equal to or greater than the critical angle is reflected internally away from the microscope objective and lost for the purpose of imaging the liquid sample. Since the curvature of the surface 14 of the liquid is greater around the wall of the well, standard bright-field illumination techniques produce images with a relatively dark outer ring that hinders the process of identifying and counting crystals present in the corresponding area of the well. As much as 30% of the droplet is lost as a result of the darker ring imaged by this type of bright-field illumination.

Another approach used in the art is dark-field illumination, which is produced by blocking the light beam exiting the sample in an intermediate focal plane such that only light diffracted around the block is seen by the camera. This enhances edges within the field, but much of the light is lost and substantially greater intensities of illumination need to be used. Otherwise, noisy images are produced. As is well understood in the art, dark-field illumination also does not work well when there is a significant separation of the sample from the microscope objective or when there is substantial bending of the beam by objects that are not of interest, such as by the liquid drop, as opposed to the protein crystals within the drop.

In order to overcome these problems, scattered light is produced for bright-field illumination by introducing a diffuser between the illumination source and the sample. By placing the diffuser as close as possible to the sample, the efficiency of illumination is substantially retained and the ring effect produced by the curvature of the liquid droplet is virtually eliminated. This is because light passing through the diffuser exits at many angles, so that there is substantial amount of light that does not pass the critical-angle threshold described above. While this approach is ideal for single-well measurements, it is not compatible with high-throughput systems because it does not permit autofocusing (which requires unscattered light for proper functioning). Therefore, a separate source of illumination needs to be used for the autofocus mechanism and it typically cannot be on the same side of the sample, which adds cost and complexity to the system.

Therefore, there is still a need for fast-throughput imaging system with autofocus that does not suffer from the problems outlined above. This invention is directed at providing such a system with a single source of illumination (or a double source from the same side of the sample) adapted to implement both the imaging and autofocus functions at a very rapid pace.

### BRIEF SUMMARY OF THE INVENTION

According to one embodiment of the invention, a scatter-shutter element is used in combination with a single illumination source to alternately provide bright-field illumination for autofocus purposes and scatter-light illumination for imaging purposes. The scatter shutter consists of a transparent plate that becomes cloudy and produces scattered light practically instantaneously upon application of a voltage. Accordingly, as the sample tray is being scanned continuously through the microscope objective for data acquisition, the scatter shutter is intermittently deactivated to allow unscattered light to focus on the underside of the tray and produce autofocus signals, and then activated to produce diffuse light to better image the droplet in each well, either with or without the need to change additional optics positions. The timing of each step is synchronized so as to place the droplet in focus and centered within the field of view prior to energizing the scatter shutter and switching to the imaging mode.

According to another embodiment of the invention, a strobed arc-lamp source is used for image acquisition and a separate source, potentially a laser, is used for autofocus purposes and is kept on continuously as the sample tray is being scanned. When the scatter shutter is not energized, the laser beam produces the optical signals off the underside of the tray required to adjust the focal position of the well approaching the microscope objective. When the well is in focus and centered in the field, the scatter shutter is energized to produce diffuse light and the high-intensity arc lamp is also energized for a length of time sufficient to image the droplet in the well. In this case the dual sources ensure that no additional optics will need to change positions between focusing mode and imaging mode.

In both cases described above, the electronic scatter shutter allows one to alternately produce diffuse light for imaging drops or permit light to pass through for focusing, all with high speed and no moving parts which can induce vibration. Various other aspects and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiment and particularly pointed out in the claims. However, such drawings and description disclose but one of the various ways in which the invention may be practiced.

### BRIEF DESCRIPTION OF THE DRAWINGS

FIG. 1 is a simplified schematic representation, in elevational view, of a well of a conventional multi-well sample tray.

FIG. 2 is a schematic representation of the multi-well tray of FIG. 1 illustrating droplets of protein solution in each well with various surface heights and degrees of formation of protein crystals.

FIG. 3 is a schematic illustration of an optical microscope for the sequential testing of crystal solutions contained in a multi-well tray, wherein a scatter shutter element is used to switch the system's illumination between bright-field and scattered modes according to the invention.

FIG. 4 is picture of a protein-solution droplet in a test well, imaged using conventional bright-field illumination and showing the dark ring produced by the curvature of the top surface of the droplet in the well.

FIG. 5 shows the same sample of FIG. 4 imaged through the scatter shutter of the invention, thereby producing an image of greater clarity within which a crystal can be more clearly identified.

### DESCRIPTION OF THE PREFERRED EMBODIMENT OF THE INVENTION

The inventive aspect of this disclosure lies in the idea of using an intermittent scatter plate in the optical axis of illumination of a microscope used for high-throughput testing of multi-well trays. The intermittent light-scatter function provided by the plate allows the alternate bright-field illumination required for the operation of conventional autofocusing mechanisms and the scatter-light illumination required for uniform imaging of the entire well. In addition, the fact that both modes of illumination may be implemented from the same side of the sample tray provides construction, maintenance and operational advantages over prior-art microscope systems used for rapid sample screening.

Referring to the drawings, wherein like parts are designated throughout with like numerals and symbols, FIG. 2 illustrates in schematic cross-sectional view a multi-well plate 20 used to carry out high-throughput screening of protein crystal samples according to the invention. Each well 10 is aligned in a row that is scanned in front of a microscope objective 22 (or vice versa) for the purpose of imaging the droplet 12 contained in each well and identifying the presence of protein crystals 24 that may have formed in the well. As illustrated, the droplets form a lens structure in the wells by virtue of their curved top surfaces 14 and their height in the various wells are not necessarily the same because of the different amounts of liquid originally placed in the wells and the different effects produced by the incubation stage. The images of the wells are processed in conventional manner to carry out the crystal identification and counting functions. The tray 20 is mounted on a stage (not shown) that allows the continuous translation of the tray to successively position each well in the tray under the microscope objective 22.

FIG. 3 illustrates an embodiment of the invention wherein a switching scatter-shutter plate 26 is introduced into the illumination system. The plate is activated intermittently by an electrical signal provided by a computer 28 in synchrony with the operation of an x,y-scanner 30 adapted to position each well 10 in optical alignment with the microscope objective 22. From the bottom of the tray 20 (opposite to the imaging side), a light source 32 is used to project a beam that is collimated by a lens 34, passed through a neutral-density filter 36, and then through a beam splitter 38 toward the scatter shutter 26. Under deactivated conditions, the scatter shutter 26 is transparent and the light through it is reflected off the underside 40 of the tray 20 and is redirected by the beam splitter and appropriate optics toward a conventional autofocus mechanism 44. In turn, the signal generated by the autofocus mechanism 44 is used, through the computer 28, to drive a z-scanner 46 to adjust the distance between the objective microscope 22 and the well 10 that is in in the process of being positioned under it, so that the microscope is focused at the desired level within the droplet 12 in the well.

Subsequent to the autofocus adjustment, the scatter shutter 26 is energized, thereby producing scattered light that illuminates the droplet 12 through the transparent bottom of the sample plate 20. The scattered light illuminates substantially uniformly across the section of the droplet, thereby producing an image wherein differences in intensity signals correspond to structural boundaries, such as produced by the presence of a crystal 24 within the liquid droplet. The light is collected by the microscope objective 22 and viewed by an eyepiece or detected by a sensor or camera 48. The data so acquired may be digitized in a conversion unit 50 and stored in the computer 28 for processing and/or viewing on a monitor 52, either on line or after the scan is completed.

In one embodiment of the invention, the images are acquired by precisely timing the acquisition of sensor 48 over a small time period so that a clear picture is generated even though the sample tray 20 is in motion with respect to the microscope objective 22 and the sensor 48. In another embodiment, the fast image acquisition is accomplished by strobing the light source 32, which could be an arc lamp, laser, or LED. In this case, an additional source 54, preferably a low-intensity laser, may be used on axis with the source 32 to illuminate the system for autofocusing purposes.

Using a solid state liquid crystal display shutter (such as Anteryon's Model LCP250) and conventional microscope hardware, stage mechanisms, optics, and processing equipment, it was possible to process images continuously at a rate of about 8,000 images per hour. The autofocus was of the continuous laser type and adapted to operate on reflections from the underside of the tray. An offset of 100 micrometers was used into the autofocus in order to focus the objective approximately in the center of the well drops. A HeNe laser source was used for autofocus purposes in combination with a Xenon flash lamp arc lamp for image acquisition. The arc lamp was strobed to provide illumination for about a 50 milliseconds period at about a 3 Hz frequency

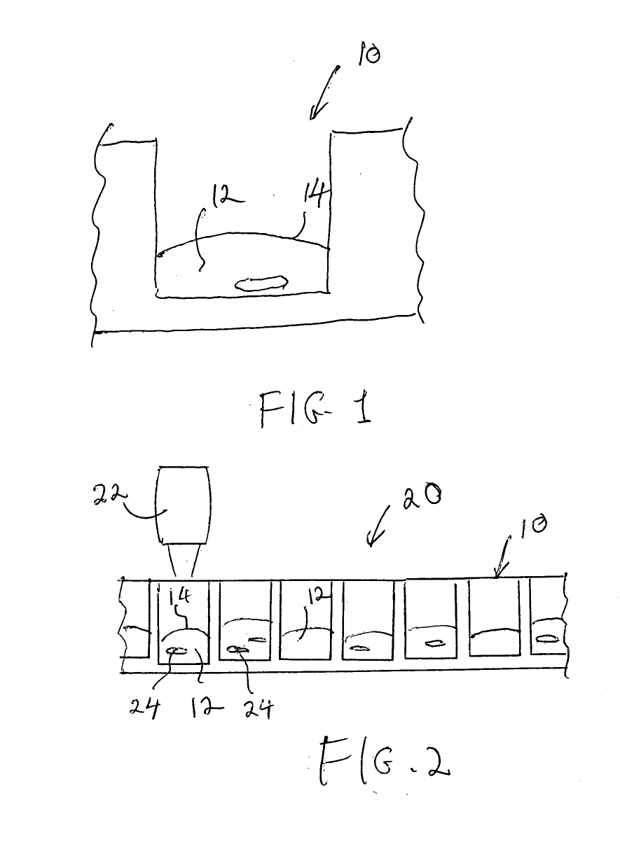

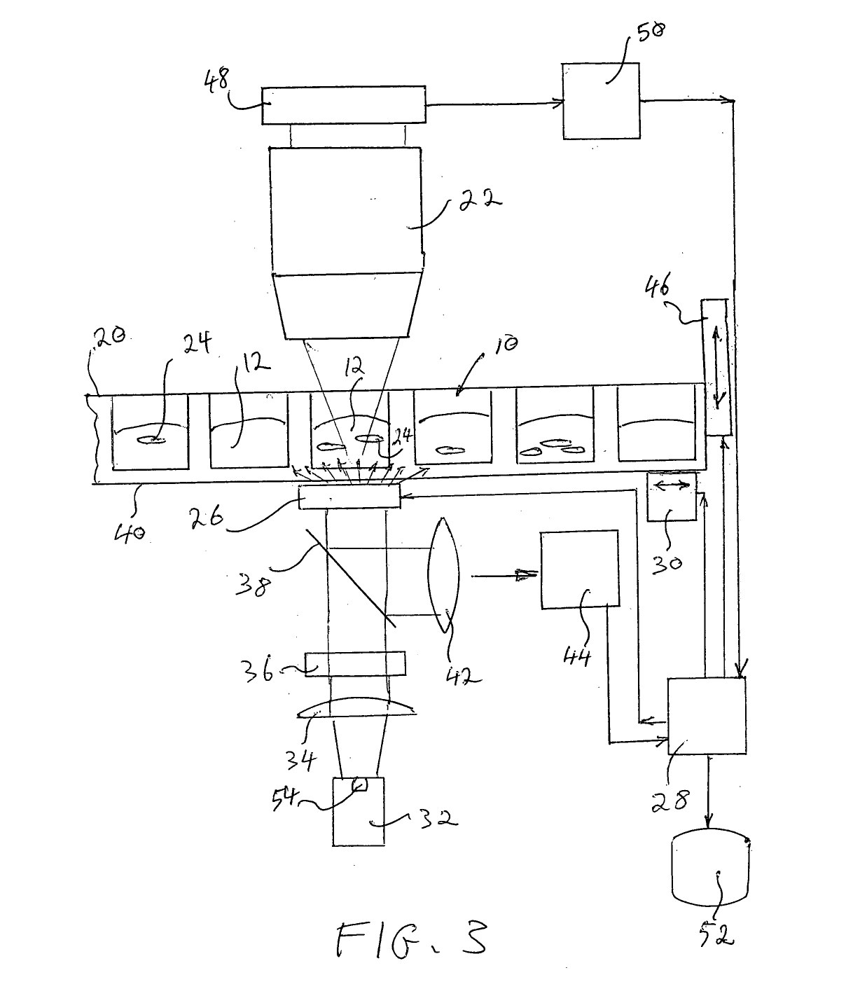

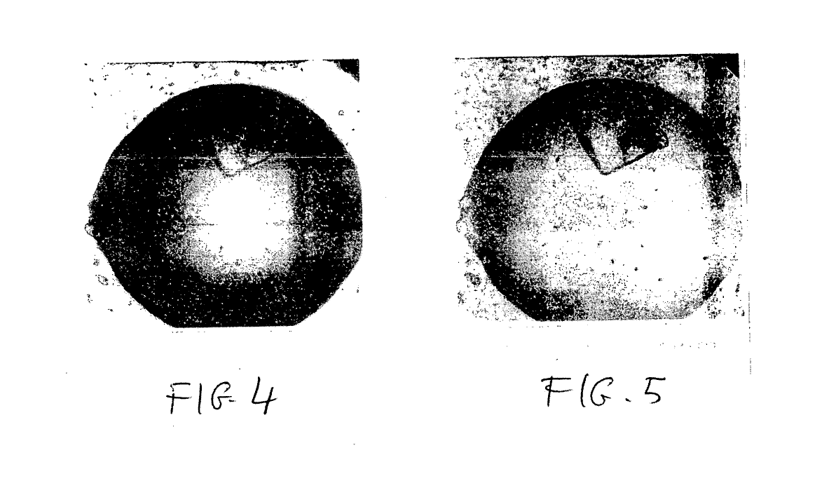

FIGS. 4 and 5 illustrate typical images of protein solution droplets in one of a multi-well sample tray. The image of FIG. 4 was acquired using conventional bright-field illumination. It clearly shows the dark ring produced by the curvature of the droplet in the well. As a result to the darker illumination within the ring, it is difficult to discern the presence of the crystal in the liquid. FIG. 5 shows the same sample imaged through the scatter shutter of the invention. The image illustrates the greater clarity with which the crystal can be seen, which enables automatic analysis and screening of the samples.

It is understood that the concept of the invention could be implemented in similar fashion by any means that permitted the alternate illumination in bright-field mode and scattered-field mode. Thus, the idea could conceivably be implemented by a mechanism that allowed rapid switch between modes, or other equivalent means, but at substantially greater cost, complication, and loss of efficiency.

Therefore, various changes in the details, steps and components that have been described may be made by those skilled in the art within the principles and scope of the invention herein illustrated and defined in the appended claims. While the invention has been shown and described herein in what is believed to be the most practical and preferred embodiments, it is recognized that departures can be made therefrom within the scope of the invention, which is not to be limited to the details disclosed but is to be accorded the full scope of the claims so as to embrace any and all equivalent apparatus and methods.

We claim:

1. In an optical system for imaging multiple samples in a plurality of wells of a multi-well tray, wherein a scanning mechanism is provided for sequentially aligning said wells with focusing optics within the system, wherein an autofocus mechanism is provided for placing the wells at a predetermined distance from the focusing optics, and wherein at least one light source is provided to illuminate a reference point to generate a signal for the autofocus mechanism and illuminate the wells to produce an image acquired by a light detector through the focusing optics, the improvement comprising:
a switching scatter element adapted to scatter light produced by said light source when the light source illuminates the wells.

2. The optical system recited in claim 1, wherein said at least one light source comprises a pulsed source that is used to illuminate the wells during image acquisition.

3. The optical system recited in claim 1, wherein said at least one light source comprises a pulsed source that is used to illuminate the wells for image acquisition and a continuous source that is used to illuminate said reference point for autofocus operation.

4. The optical system recited in claim 1, wherein said switching scatter element consists of a solid-state liquid crystal display shutter.

5. The optical system recited in claim 1, wherein said reference point is located on an underside of the tray.

6. The optical system recited in claim 1, wherein said reference point is located on a bottom surface of one of said wells.

7. The optical system recited in claim 1, wherein said light detector is adapted for selective operation during each period of image acquisition.

8. The optical system recited in claim 1, wherein said at least one light source comprises a pulsed source that is used to illuminate the wells for image acquisition and a continuous source that is used to illuminate said reference point for autofocus operation; wherein said switching scatter element consists of a solid-state liquid crystal display shutter; and wherein said reference point is located on an underside of the tray.

9. The optical system recited in claim 8, wherein the system is a microscope.

10. An optical system for imaging multiple samples contained in a plurality of wells of a multi-well tray, comprising:
focusing optics;
a scanning mechanism for aligning said wells with the focusing optics;
an autofocus mechanism for placing said wells at a predetermined distance from the focusing optics;
a light source illuminating a reference point to generate a signal for said autofocus mechanism and illuminating said wells to produce an image acquired by a light detector through said focusing optics; and
a switching scatter element adapted to scatter light produced by said light source when the light source illuminates the wells.

11. The optical system recited in claim 10, wherein said light source comprises a pulsed source that is energized to illuminate the wells during image acquisition.

12. The optical system recited in claim 10, wherein said light source comprises a pulsed source that is energized to illuminate the wells for image acquisition and a continuous source used to illuminate said reference point for autofocus operation.

13. The optical system recited in claim 10, wherein said switching scatter element consists of a solid-state liquid crystal display shutter.

14. The optical system recited in claim 10, wherein said reference point is located on an underside of the tray.

15. The optical system recited in claim 10, wherein said reference point is located on a bottom surface of one of said wells.

16. The optical system recited in claim 10, wherein said light detector is adapted for selective operation during each period of image acquisition.

17. The optical system recited in claim 10 wherein said light source comprises a pulsed source that is used to illuminate the wells for image acquisition and a continuous source that is used to illuminate said reference point for autofocus operation; wherein said switching scatter element consists of a solid-state liquid crystal display shutter; and wherein said reference point is located on an underside of the tray.

18. The optical system recited in claim 10, wherein the system is a microscope.

19. In an optical system for imaging multiple samples in a plurality of wells of a multi-well tray, wherein a scanning mechanism is provided for sequentially aligning said wells with focusing optics, wherein an autofocus mechanism is provided for placing the wells at a predetermined distance from the focusing optics, and wherein a light source is provided to illuminate a reference point to generate a signal for the autofocus mechanism and illuminate the wells to produce an image acquired by a light detector through said focusing optics, a method for reducing intensity variations caused by surface curvatures in samples contained in said wells, the method comprising the following steps:
providing a switching scatter element in the optical axis of said light source; and
intermittently activating said switching scatter element to produce scattered light when the light source illuminates the wells.

20. The method of claim 19, wherein said light source comprises a pulsed source that is energized to illuminate the wells during image acquisition.

21. The method of claim 19, wherein said light source comprises a pulsed source that is energized to illuminate the wells for image acquisition and a continuous source used to illuminate said reference point for autofocus operation.

22. The method of claim 19, wherein said switching scatter element consists of a solid-state liquid crystal display shutter.

23. The method of claim 19, wherein said reference point is located on an underside of the tray.

24. The method of claim 19, wherein said reference point is located on a bottom surface of one of said wells.

25. The method of claim 19, wherein said light detector is adapted for selective operation during each period of image acquisition.
